(19) United States
(12) Patent Application Publication
(10) Pub. No.: US 2015/0021453 A1
(43) Pub. Date: Jan. 22, 2015

(54) COLLAPSIBLE SUPPORT STRUCTURE

(71) Applicant: BRAVO SPORTS, Santa Fe Springs, CA (US)

(72) Inventors: Andrew P. Brassard, Huntington Beach, CA (US); Jack B. Lovley, II, Lake Forest, CA (US); Mark Groenhuyzen, Huntington Beach, CA (US); Leonardo Pais, Huntington Beach, CA (US); Joseph C. Klingl, Los Angeles, CA (US)

(21) Appl. No.: 14/366,479

(22) PCT Filed: Dec. 20, 2012
(86) PCT No.: PCT/US12/70893

§ 371 Date: Jun. 18, 2014

Related U.S. Application Data
(60) Provisional application No. 61/579,590, filed on Dec. 22, 2011.

(51) Int. Cl. E04G 1/32; E04G 1/15; A45F 5/00; F16M 11/00

(52) U.S. Cl. CPC E04G 1/32; F16M 11/00; E04G 1/15; A45F 5/00
USPC 248/544; 248/346.3; 29/401.1

(57) ABSTRACT

A collapsible support structure that can transition from a folded position to an unfolded position can include a plurality of poles, a plurality of support members connected to a plurality of sliders, and a bottom supporting portion. The collapsible support structure can be configured for a variety of purposes, including an enclosure for a pet, such as a kennel; a playpen, such as a children's castle; a storage container; or a cot.

### INCORPORATION BY REFERENCE TO ANY PRIORITY APPLICATIONS

Any and all applications for which a foreign or domestic priority claim is identified in the Application Data Sheet as filed with the present application are hereby incorporated by reference and made a part of the present disclosure.

### BACKGROUND

### Field of the Invention

The invention disclosed herein relates generally to collapsible support structures.

### SUMMARY

A collapsible support structure generally comprises a plurality of poles, a plurality of support members connected to the plurality of poles using a plurality of sliders, and a bottom portion. In some embodiments, each support member is connected to at least another support member to form a pivot such that the plurality of support members forms a plurality of pivots. The plurality of support members can be moveable about the plurality of pivots to allow the collapsible support structure to transition between a folded position in which the plurality of poles are spaced close together and an unfolded position in which the plurality of poles are spaced further apart. The support members can form a crisscross pattern, such as similar to the shape of an “X”, around a perimeter of the collapsible support structure when the support members are in the unfolded position.

In some embodiments, the collapsible support structure further comprises a top portion that can be configured to provide a roof to the collapsible support structure when it is in an unfolded position. For example, the top portion can function as a canopy to provide shade and shelter. In some embodiments, the top portion can be removable.

In some embodiments, the collapsible support structure further includes side portions that surround the plurality of poles and enclose an interior volume. The side portions can be made of various materials, including mesh materials and solid fabrics. In some embodiments, the side portions can be removable. The side portions can further include an opening portion that can selectively provide access to the interior volume or be closed such that no access is provided. For example, the opening portion can include a zipper to alternate between an open state that provides access to the interior volume and a closed state.

In some embodiments, the collapsible support structure further includes wheels to provide mobility. The collapsible support structure can also provide castors for added mobility. In addition, any other means may be added to the collapsible support structure to provide additional mobility.

In various embodiments, the collapsible support structure can be configured for a variety of purposes, including an enclosure for pets, such as a kennel; a playpen for children, such as a children's castle; a storage container; and a cot.

In some embodiments, the collapsible support structure can be configured for transport in a carry case when the collapsible support structure is in a folded position. For example, the carry case can be configured as a backpack.

In some embodiments, a collapsible support structure configured to be placed on a substantially horizontal surface comprises a bottom portion configured to support at least one of a human, a pet, or a physical object when the collapsible support structure is in an unfolded state; a plurality of poles, wherein each of the plurality of poles comprises a top end and a bottom end; a plurality of slidable connectors; and a plurality of support members, wherein each of the plurality of support members comprises a first end and a second end, the first end of each of the plurality of support members is configured to be connected to the bottom end of a first pole of the plurality of poles, and the second end of each of the plurality of support members is configured to be connected to one of the slidable connectors of the plurality of slidable connectors, the slidable connector configured to slidably connect to a second pole of the plurality of poles, wherein the first pole and second pole are different; wherein the plurality of slidable connectors are configured so that sliding the second end of each of the plurality of support members from a first position to a second position closer to the bottom end of each pole of the plurality of poles transitions the collapsible support structure from a folded state to an unfolded state.

In some embodiments, the plurality of slidable connectors are configured to support the bottom portion in an elevated position off the ground when the collapsible support structure is in the unfolded state. The collapsible support structure can comprise a top portion configured to be removably attached to the top end of each of the plurality of poles. The collapsible support structure can comprise side portions configured to enclose an interior volume when the collapsible support structure is in the unfolded state. The side portions of the collapsible support structure can comprise an opening portion that can be configured to provide access to the interior volume and to be closed such that less access is provided to the interior volume.

In some embodiments, the plurality of support members form a crisscross pattern around a perimeter of the collapsible support structure when the collapsible support structure is in the unfolded state. The collapsible support structure can comprise one or more wheels. The collapsible support structure can be configured for use as at least one of: an enclosure for a pet, a storage container, a playpen, or a cot. The collapsible support structure can be used in combination with a carry case configured to transport the structure when the collapsible support structure is in the folded state. The carry case can comprise a back pack.

In some embodiments, a method of using a collapsible support structure, said collapsible support structure comprising a bottom portion; a plurality of poles, each of the plurality of poles comprising a top end and a bottom end; and a plurality of support members, each of the plurality of support members comprising a first end and a second end, the second end comprising a slidable connector, said method can comprise: sliding each of said slidable connectors from a first position along each of the plurality of poles to a second position along each of the plurality of poles to transition the collapsible support structure from a folded state to an unfolded state; and providing a gap between the bottom portion and the ground when the support structure is in the unfolded state, the bottom portion capable of supporting at least one of a human, a pet, or a physical object on the bottom portion when the collapsible support structure is in the unfolded state.

In some embodiments of the method, the slidable connectors support the bottom portion in an elevated position off the ground when the collapsible support structure is in the unfolded state. The method can further comprise attaching a top portion adjacent the top end of each of the plurality of poles. The method can further comprise enclosing an interior volume of the collapsible support structure using side portions. The method can further comprise an opening in the side portion to provide access to the interior volume of the collapsible support structure. The method can further comprise extending the plurality of support members to form a crisscross pattern around a perimeter of the collapsible support structure when the collapsible support structure is in the unfolded state. The method can further comprise sliding the collapsible support structure using one or more wheels. The method can further comprise using the collapsible support structure for at least one of: an enclosure for a pet, a storage container, a playpen, or a cot. The method can further comprise carrying the collapsible support structure with a carry case. The method can further comprise carrying the carry case as a back pack.

### BRIEF DESCRIPTION OF THE DRAWINGS

FIG. 1 is a perspective view of an embodiment of a collapsible support structure comprising side portions and a top portion.

FIG. 2 is a perspective view of an embodiment of a collapsible support structure comprising side portions and a top portion.

FIG. 3 is a perspective view of an embodiment of a collapsible support structure comprising side portions and a top portion.

FIG. 4 is a perspective view of an embodiment of a collapsible support structure comprising side portions and a top portion.

FIG. 5 is a perspective view of an embodiment of a collapsible support structure comprising a top portion.

FIG. 6 is a perspective view of an embodiment of a collapsible support structure comprising a top portion.

FIG. 7 is a perspective view of an embodiment of a collapsible support structure comprising a top portion.

FIG. 8 is a perspective view of an embodiment of a collapsible support structure comprising a top portion.

FIG. 9 is a perspective view of an embodiment of a collapsible support structure comprising a top portion.

FIG. 10 is a perspective view of an embodiment of a collapsible support structure in a collapsed position.

FIG. 11 is a perspective view of an embodiment of a collapsible support structure comprising wheels and a carry case.

### DETAILED DESCRIPTION OF THE PREFERRED EMBODIMENTS

For the purpose of understanding particular embodiments, reference will now be made to the drawings.

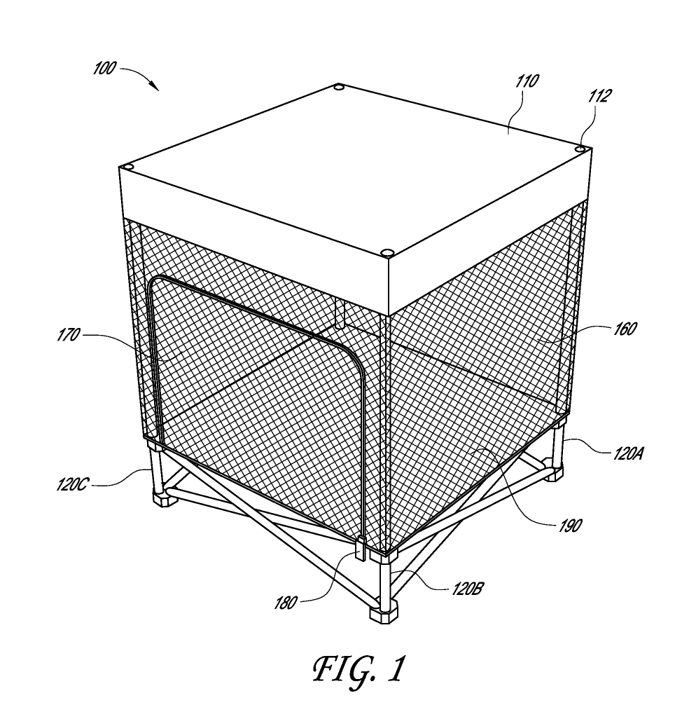

FIG. 1 illustrates a perspective view of an embodiment of a collapsible support structure comprising side portions and a top portion in which the collapsible support structure is in an unfolded position. In particular, the collapsible support structure 100 of FIG. 1 comprises, among other things, a plurality of poles 120A, 120B, 120C, and 120D (not shown), a top portion 110, attachment piece 112, side portions 160, an opening portion 170, a zipper 180, and a bottom portion 190.

As shown in FIG. 1, the collapsible support structure 100 comprises four poles 120A, 120B, 120C, and 120D (not shown). In alternative embodiments, the collapsible support structure can comprise as few as three poles or as many as five or more poles.

The collapsible support structure 100 further comprises a bottom portion 190. When the collapsible support structure 100 is in an unfolded position, the bottom portion 190 extends generally horizontally and can be elevated from the ground surface. As such, the bottom portion can provide vertical support. For example, depending on the application for the collapsible support structure, bottom portion 190 can be configured to support any of a small or large pet, a child, an adult, or any physical object.

The bottom portion 190 can comprise a solid fabric. Alternatively, the bottom portion 190 can comprise any other material or fabric, including mesh materials, polyester, and ballistic nylon. Preferably, the bottom portion 190 comprises a flexible material that is capable of being folded. In preferred embodiments, the bottom portion 190 comprises a material or fabric that is machine-washable. The material or fabric of the bottom portion 190 can be UV protected and mildew resistant. In addition, the bottom portion 190 can comprise webbing around its perimeter in an “X” shape or any other combination of patterns.

The top portion 110 can be configured as a canopy to provide shade to the interior of the collapsible support structure. As shown, the top portion 110 extends generally horizontally and can be substantially parallel to a ground surface. In other embodiments, the top portion can be provided at an angle to a ground surface.

The top portion 110 comprises a solid fabric. Alternatively, the top portion 110 can comprise any other material or fabric, including mesh materials, polyester, and ballistic nylon. In preferred embodiments, the top portion 110 comprises a material or fabric that is machine-washable. The material or fabric of the top portion 110 can be UV protected and mildew resistant.

The top portion 110 can be attached to the structure by several attachment pieces, such as attachment piece 112. In particular, attachment piece 112 can be any type of fastener, including a thumbscrew-type fastener and a coin-slot head-type fastener. Preferably, the attachment pieces connect the top portion to the tops of the plurality of poles. For example, attachment piece 112 connects the top portion 110 with the top of pole 120A. Removal of the attachment pieces can provide for easy removal of the top portion 110.

In alternative embodiments, the top portion is not connected with attachment pieces. Instead, the top portion can rest on top of the plurality of poles. By resting on the plurality of poles, the top portion can be easily removed for washing.

In addition, the material or fabric of top portion 110 can be supported by the plurality of poles 120A, 120B, 120C, and 120D but not otherwise supported by another structural member. In alternative embodiments, additional structural members can be used to provide support for the top portion.

In other alternative embodiments, the collapsible support structure does not comprise a top portion. If no top or side portions are provided, the plurality of poles need not necessarily extend above the bottom portion.

As shown in FIG. 1, the collapsible support structure can include side portions 160 around the exterior of the structure. As such, the side portions 160 enclose an interior volume. The side portions 160 can be formed from a textilene mesh material. Alternatively, the side portions can comprise any other material or fabric, including other mesh materials, polyester, and ballistic nylon. The side portions can comprise the same or different material or fabric as that used for the top portion. In preferred embodiments, the side portions 160 comprise a material or fabric that is machine-washable. The material or fabric of side portions 160 can be UV protected and mildew resistant. The side portions 160 can be attached to the plurality of poles 120A, 120B, 120C, and 120D. In addition, the side portions 160 can be removed for washing.

The side portions 160 can further include an opening portion 170 that can selectively provide access to the interior volume or be closed such that no immediate access is provided. For example, the opening portion 170 can act as a door. Various mechanisms can be provided to allow the opening portion 170 to open and close. For example, as shown in FIG. 1, a zipper 180 can be provided between the opening portion 170 and the side portion 160. When zipped up, the opening portion 170 is closed such that no access is provided to the interior volume. When unzipped, the opening portion 170 is open and allows access to the interior volume. Although illustrated in FIG. 1 as a rectangular shape with rounded corners, the opening portion 170 can be any shape and size. Furthermore, the opening portion 170 can be provided in any location on the side portions.

The side portions 160 can be secured to the collapsible support structure in a variety of ways. For example, in some embodiments, the side portions 160 can be fitted about the plurality of poles such that the force of friction is sufficient to keep the side portions 160 in a raised position. Alternatively, various attachment mechanisms may be provided to connect the side portions to the plurality of poles, including coin fasteners, coin-slot head-type fasteners, screws, plug and socket, hook and loop connections, as well as any other means of connection.

In alternative embodiments, the opening portion can be provided in the top portion. For example, in some embodiments the collapsible support structure is configured as an instant storage container. Providing the opening portion in the top portion can facilitate vertical access to the storage container. Alternatively, multiple opening portions may be provided. In addition, a single opening can extend to more than one surface of the support structure.

The opening portion can be made of any material or fabric. The opening portion can be made of the same material or fabric as the side portions or top portion, or the opening portion can be made of a different material or fabric. In the embodiment illustrated in FIG. 1, the opening portion 170 is made of the same mesh material as the side portions 160. In some embodiments, the opening portion can be made of a clear material, such as a clear plastic, to form a window.

The dimensions in FIG. 1, like any of the dimensions herein, are exemplary only. For example, while the top portion 110 can be formed in dimensions of approximately 24 inches long by 24 inches wide, with a 4 inch overhang, these dimensions are provided solely as an example, and the top portion 110 can be formed in a multitude of other shapes and dimensions.

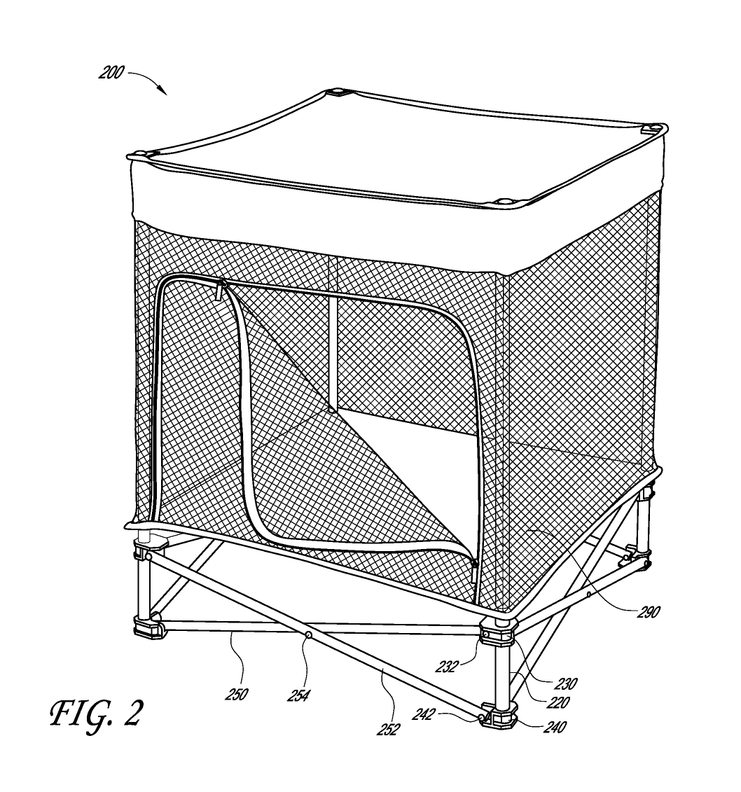

FIG. 2 illustrates a perspective view of an embodiment of a collapsible support structure comprising side portions and a top portion in which the collapsible support structure is in an unfolded position. In particular, the collapsible support structure 200 of FIG. 2 comprises, among other things, pole 220, support members 250, 252, slider 230, fasteners 232, 242, pivot 254, bottom pole support 240, and bottom portion 290.

Support member 250 can connect to the pole 220 through the slider 230. A person of ordinary skill will appreciate the variety of mechanisms that allow the support member 250 to connect to the slider 230. For example, any mechanism that connects the support member 250 to the slider 230 and provides for the support member 250 to be rotatable while transitioning from a folded to an unfolded position can be used.

In addition, support member 252 can connect to the pole 220 through the bottom pole support 240. Alternatively, support member 252 can connect directly to the pole 220. Support member 250 can be rotatably connected to support member 252 to form a pivot 254. The support members 250 and 252 can be movable about the pivot 254 to facilitate transition between a folded position in which the pole 220 is spaced substantially close to the other poles and an unfolded position in which the pole 220 is spaced apart from the other poles. FIG. 2 shows the support members 250 and 252 in an unfolded position such that the plurality of poles are spaced apart. In this unfolded position, the support members 250 and 252 can form a crisscross pattern similar to the shape of an “X.”

The slider 230 can be attached to the pole 220 and can comprise a hollow portion to facilitate movement of the slider along the pole 220. The terms “slider” and “slidable connector” are used interchangeably throughout and have the same meaning. A fastener 232 can be used to hold the slider together. The sliders can provide added vertical support to the bottom portion 290. In some embodiments, the fastener 232 can facilitate holding the slider 230 in place along the pole 220.

The “X”-member structure described above with respect to a front facing side of the collapsible support structure 200 can be repeated on each of the other sides of the collapsible support structure. For example, the collapsible support structure 200 comprises four poles, eight support members, four pivots, four sliders, and four bottom pole supports.

The bottom pole supports, including bottom pole support 240, can serve as feet that help to anchor the collapsible support structure 200. The bottom pole supports also may comprise spikes, such as those that may be used for a tent, to anchor the collapsible support structure to the ground in an outdoor location. The bottom pole supports may comprise a rough texture to provide added traction between the bottom pole supports and the ground.

A primary objective of the collapsible support structure 200 is to facilitate quick transition from a folded position to an unfolded position. In a folded position, the poles can be spaced substantially close to the other poles, the sliders can be placed in a vertically raised position along the poles, and the support members can be aligned or nearly aligned with each other as well as the poles. As such, a cross-sectional footprint of the collapsible support structure 200 can be at a minimum when in a folded position. In an unfolded position, the poles can be spaced relatively farther apart, the sliders can be placed in a vertically lowered position along the poles, and the support members are not aligned or nearly aligned in the same direction as the poles. In an unfolded position, a cross-sectional footprint of the collapsible support structure 200 can be at a maximum.

The extent to which the collapsible support structure 200 can unfold, and the extent to which the sliders can slide down the poles, can be limited by the size of the bottom portion 290. For example, when the collapsible support structure is unfolding, the support members connected to the sliders can push outwardly on the poles as the structure expands. As the sliders move down the poles, the support members can push the poles outwards. The bottom portion 290, which generally comprises a flexible material, does not initially resist this expansion. However, the bottom portion 290 is of a limited size. As the structure continues to unfold and expand, at a certain point the bottom portion 290 will become taught and no longer able to expand. At that point, the bottom portion 290 can pull inwards on the poles and balance the outward pressure from the support members and sliders. At that point, the support members can no longer expand outwards, and the sliders can no longer continue to move vertically down the poles. At that point, the collapsible support structure is in an unfolded position. The bottom portion 290 can be substantially horizontal and raised above a ground surface. Alternatively, the bottom portion may be adjacent to the ground. The sliders can provide added vertical support to the bottom portion 290 to maintain it in a raised position above the ground. For example, sufficient support can be provided to the bottom portion 290 to support any of a small or large pet, a child, an adult, or any physical object. In the event the bottom portion is removed, the sliders generally can continue to move down the poles until they contact the bottom pole supports.

The bottom portion can be connected to the sliders by way of an attachment piece. For example, the attachment piece can be any means of providing a connection between the bottom portion and the sliders, including a screw, a plug and socket, and a hook and loop mechanism. By connecting the bottom portion and the sliders, an attachment piece facilitates automatic pulling of the bottom portion into place as the collapsible support structure is expanded from a folded position to an unfolded position. In alternative embodiments, and as illustrated in FIG. 2, the bottom portion is not necessarily directly connected to the sliders. In these embodiments, the bottom portion can be slid down the poles manually once the collapsible support structure is in an unfolded position. In addition, the same or another attachment piece can be connected to the sliders to hold the sliders in place vertically along the poles. For example, the attachment piece connecting the sliders in place vertically along the poles can prevent the sliders and bottom portion from rising along the poles when a heavy object is placed on the bottom portion, thereby facilitating the support structure remaining in an unfolded position.

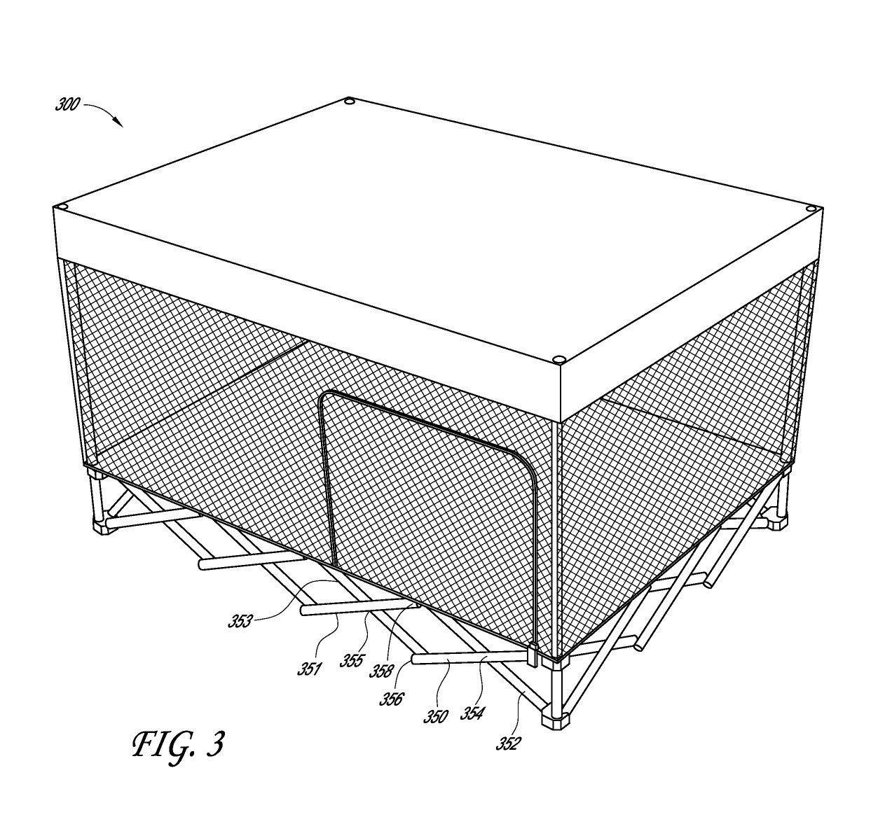

FIG. 3 illustrates a perspective view of an embodiment of an enlarged collapsible support structure 300 comprising side portions and a top portion in which the collapsible support structure is in an unfolded position.

The “X”-members such as described with respect to FIG. 2 may be combined together with one another to form additional “X”-members. For example, a collapsible support structure 300 can comprise support members 350, 351, 352, 353, center pivots 354, 355, and end pivots 356, 358.

Support members 350, 352 can be movable about center pivot 354. Similarly, support members 351, 353 can be movable about center pivot 355. Support members 350, 353 can be movable about end pivot 356. Similarly, support members 351, 352 can be movable about end pivot 358.

FIG. 3 shows the support members in an unfolded position such that a plurality of poles are spaced apart. In the unfolded position, the support members 350, 352 and support members 351, 353 can each form a crisscross pattern similar to the shape of an “X.” This “X”-member structure can be repeated as many or as few times as needed around the perimeter of the collapsible support structure. For example, the collapsible support structure 300 comprises four poles, twenty-eight support members, fourteen center pivots, and twenty end pivots.

The dimensions in FIG. 3, like any of the dimensions provided herein, are exemplary only. For example, while the top portion of the collapsible support structure 300 can be formed in dimensions of approximately 48 inches long by 36 inches wide, with a 4 inch overhang, these dimensions are provided solely as an example, and the top portion can be formed in a multitude of other shapes and dimensions.

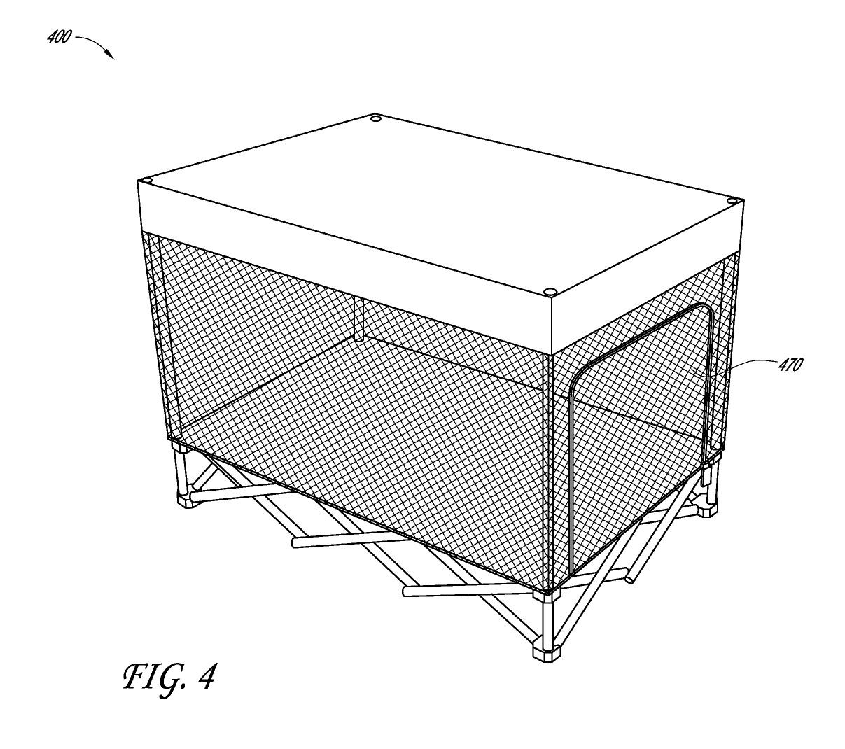

FIG. 4 illustrates a perspective view of another embodiment of a collapsible support structure 400 comprising side portions and a top portion in which the collapsible support structure is in an unfolded position. The collapsible support structure 400 comprises, among many other things, an opening portion 470. As shown, the horizontal cross section of the unfolded collapsible support structure 400 comprises a rectangular shape. The opening portion 470 can be located on the relatively narrow side of the rectangle. Alternatively, the opening portion 470 can be located on any other side and in any other position.

The dimensions in FIG. 4, like any of the dimensions provided herein, are exemplary only. For example, while the top portion of the collapsible support structure 400 can be formed in dimensions of approximately 36 inches long by 24 inches wide, with a 4 inch overhang, these dimensions are provided solely as an example, and the top portion can be formed in a multitude of other shapes and dimensions.

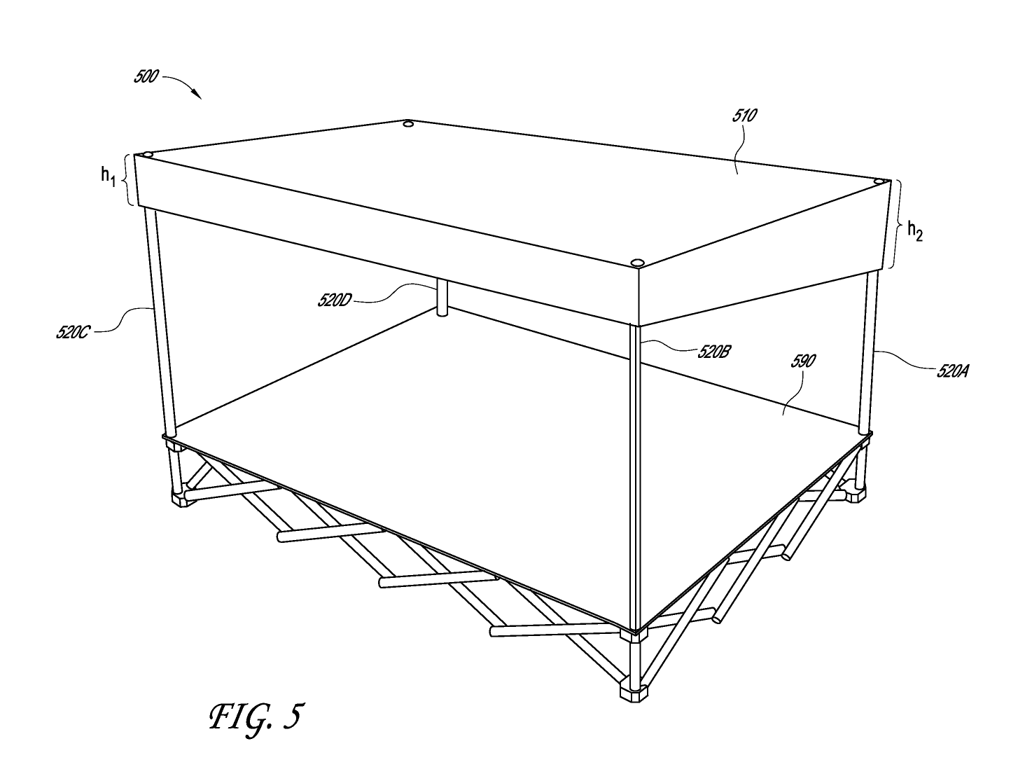

FIG. 5 illustrates a perspective view of an embodiment of a collapsible support structure comprising a top portion in which the collapsible support structure is in an unfolded position. In particular, the collapsible support structure 500 comprises, among other things, a plurality of poles 520A, 520B, 520C, and 520D, a top portion 510, and a bottom portion 590.

As shown in FIG. 5, the collapsible support structure 500 can be lacking side portions that would form a barrier around the structure. By lacking side portions, ease of movement onto and off of the bottom portion 590 is facilitated. For example, by lacking side portions, a pet, such as a dog, or a person may more freely move onto and off of the bottom portion 590.

The top portion 510 can be provided with a downward sloping angle. For example, the poles 520B, 520C can be comparatively taller than the poles 520A, 520D. As such, the top portion 510 can form a downward sloping angle as it extends from atop poles 520B, 520C down to poles 520A, 520D. Thus, liquid such as rain water will run off of the top portion and not accumulate.

In addition, the top portion 510 can have varying degrees of overhang on different sides. For example, on the taller side, the top portion 510 can have an overhang h₁, and on the shorter side, the top portion 510 can have an overhang h₂. As shown in FIG. 5, overhang h₂ can be longer than overhang h₁. Alternatively, in other embodiments, overhang h₂ can be shorter than overhang h₁. Furthermore, the overhangs may also be asymmetrical. The overhangs may also form a visually-pleasing pattern.

The dimensions in FIG. 5, like any of the dimensions provided herein, are exemplary only. For example, while the poles 520B and 520C can have a height of 32.5 inches and the poles 520A and 520D are can have a height of 28.5 inches, these dimensions are provided solely as an example, and the heights of the poles can be formed in a multitude of other combinations.

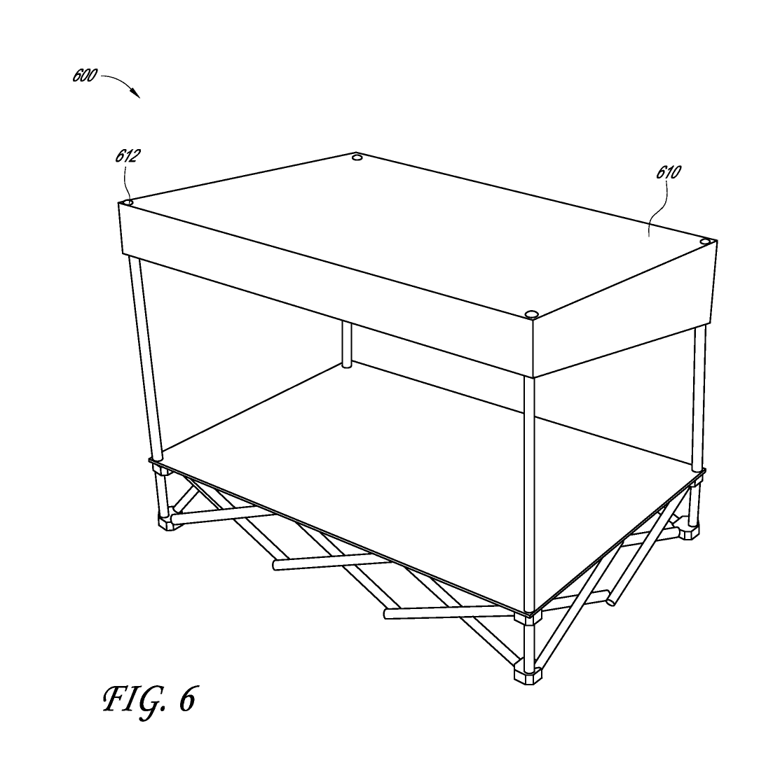

FIG. 6 illustrates a perspective view of an embodiment of a collapsible support structure comprising a top portion in which the collapsible support structure is in an unfolded position. The top portion 610 can be held in place using caps with plastic button screws 612 that fit on top of the plurality of poles. The dimensions shown in FIG. 6, like any of the dimensions provided herein, are exemplary only.

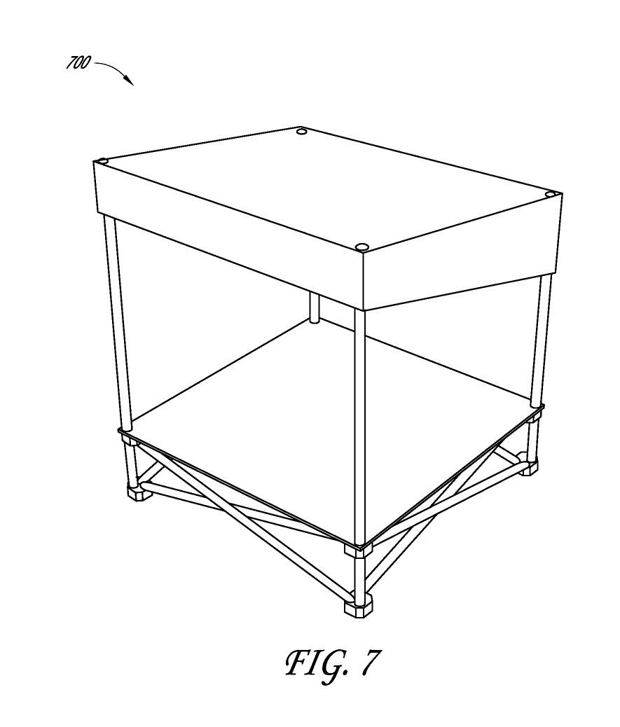

FIG. 7 illustrates a perspective view of another embodiment of a collapsible support structure comprising a top portion in which the collapsible support structure is in an unfolded position. The dimensions shown in FIG. 7, like any of the dimensions provided herein, are exemplary only.

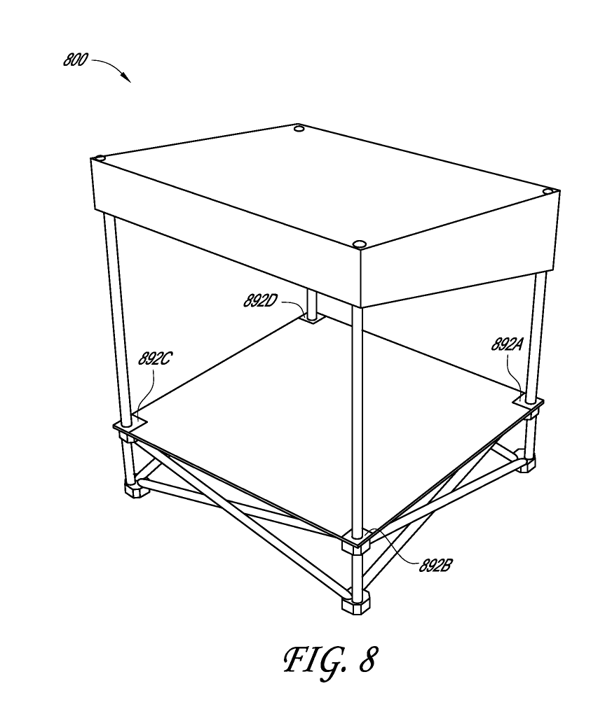

FIG. 8 illustrates a perspective view of another embodiment of a collapsible support structure comprising a top portion in which the collapsible support structure is in an unfolded position. The bottom portion can comprise reinforcement pieces 892A, 892B, 892C, and 892D that can prevent wear and tear on the edges of the bottom portion that slide along the plurality of poles.

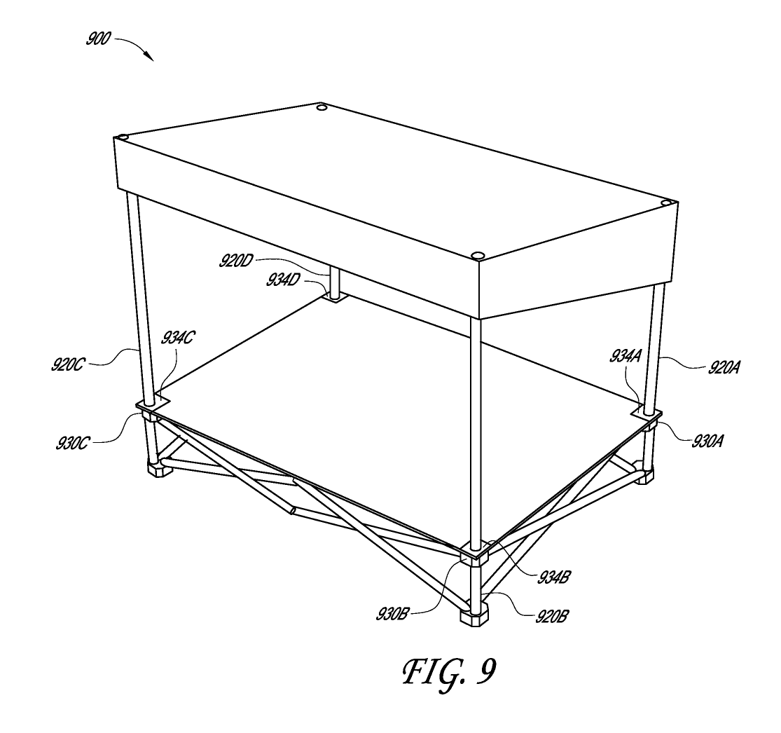

FIG. 9 illustrates a perspective view of another embodiment of a collapsible support structure comprising a top portion in which the collapsible support structure is in an unfolded position. In particular, the collapsible support structure 900 of FIG. 9 comprises, among other things, a plurality of poles 920A, 920B, 920C, and 920D, sliders 930A, 930B, 930C, and 930D (not shown), and connecting screws 934A, 934B, 934C, and 934D.

Connecting screws 934A, 934B, 934C, and 934D can connect the bottom portion to sliders 930A, 930B, 930C, and 930D (not shown). By connecting the bottom portion and the sliders, the connecting screws 934A, 934B, 934C, and 934D facilitate pulling the bottom portion into place as the collapsible support structure is expanded from a folded position to an unfolded position. Alternatively, other means of attaching the bottom portion to the sliders may be used. For example, plug and socket, hoop and loop, and other means of connection may be used. In other alternative embodiments, no attachment mechanism of the bottom portion to the sliders is provided. Instead, the bottom portion can comprise holes for each pole so that the bottom portion may slide down the poles.

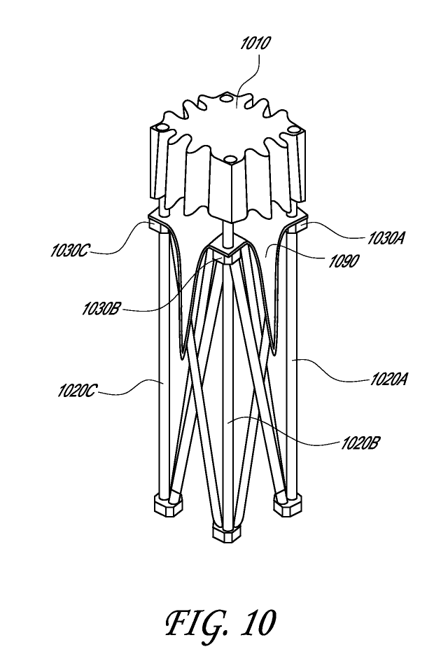

FIG. 10 illustrates a perspective view of another embodiment of a collapsible support structure comprising a top portion in which the collapsible support structure is in a folded, collapsed position. In particular, the collapsible support structure of FIG. 10 comprises, among other things, poles 1020A, 1020B, and 1020C, sliders 1030A, 1030B, and 1030C, bottom portion 1090, top portion 1010, and support members. A fourth pole is not shown.

The support members can be movable to facilitate transition between a folded position in which the poles 1020A, 1020B, and 1020C are spaced substantially closer to each other and an unfolded position in which the poles 1020A, 1020B, and 1020C are spaced further apart from the other poles. FIG. 10 shows the support members in a folded position such that the plurality of poles 1020A, 1020B, and 1020C are nearer to each other.

The sliders 1030A, 1030B, and 1030C can be slidably attached to the poles 1020A, 1020B, and 1020C. When the collapsible support structure is in a folded position, the sliders 1030A, 1030B, and 1030C can be positioned relatively closer to the top portion 1010 than when the collapsible support structure is in an unfolded position.

Additionally features found in other embodiments will now be described. Several features can be added to improve mobility of the collapsible support structure. For example, many embodiments can be combined with a carry case configured to transport a collapsible support structure when the structure is in a folded position. For example, a backpack can be used to transport the collapsible support structure.

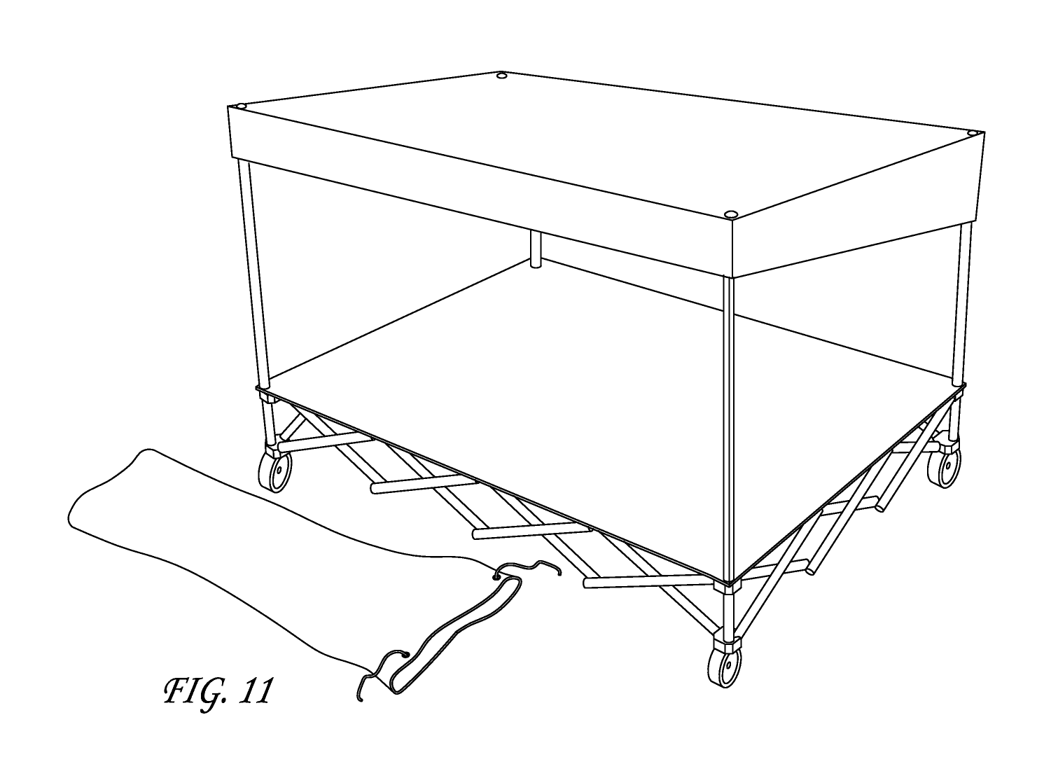

In addition, in some embodiments, the collapsible support structure further can comprise one or more wheels that provide mobility to the collapsible support structure. For example, FIG. 11 is a perspective view of an embodiment of a collapsible support structure comprising wheels.

Also, the collapsible support structure further can comprise a telescoping or hinged handle to aid the mobility of the collapsible support structure. The collapsible support structure can also be configured for transport within a carry case. For example, the collapsible support structure can also be configured for transport within a back pack. FIG. 11 is a perspective view of an embodiment of a carry case for a collapsible support structure.

In various embodiments, the collapsible support structure can be configured for a variety of purposes. In a preferred embodiment, the collapsible support structure can be configured as an enclosure for pets, such as an instant kennel. In instant kennel embodiments, the bottom portion can function as a dog bed. By being elevated, the dog bed keeps a dog cleaner and away from potentially wet grass, cold snow, hard cement, and ground insects. A breathable fabric may be provided for the dog bed to keep a dog more comfortable. In addition, the top portion can function as a canopy to provide shade to a pet. The top portion can provide sun and rain protection to a pet as the pet relaxes outdoors, helping keep the pet more comfortable. The instant kennel can include side portions comprising mesh materials and solid fabrics. In addition, the instant kennel can include a clear window as an opening portion. A zipper can be provided to open and close the window.

As the bottom portion can be elevated, cool air can be circulated underneath the bottom portion for added comfort. For example, circulation of cool air may be desirable on a warm day. In addition, warm air can be circulated underneath the bottom portion for added comfort. For example, circulation of warm air may be desirable on a cold day. In addition, circulation of air can help keep the material of the bottom portion dryer and cleaner.

In some embodiments, the bottom portion can offer a hammock-like effect for added comfort.

In another embodiment, the collapsible support structure can be configured as an instant playhouse, playpen, or castle for children. The instant playhouse, playpen, or castle for children can optionally provide an open-access top in which a top portion cover is lacking. The instant playhouse, playpen, or castle can be configured to meet or exceed CPSC standards.

In another embodiment, the collapsible support structure can be configured as an instant storage box. In this embodiment, the opening portion preferably can be located on the top portion of the structure.

In another embodiment, the collapsible support structure can be configured as a full-size instant cot for an adult or child. The instant cot can be provided with a top portion that provides shade.

The features and attributes of the specific embodiments disclosed above may be combined in different ways to form additional embodiments, all of which fall within the scope of the present disclosure. Although this invention has been described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A collapsible support structure configured to be placed on a substantially horizontal surface, comprising:
a bottom portion configured to support at least one of a human, a pet, or a physical object when the collapsible support structure is in an unfolded state;
a plurality of poles, wherein each of the plurality of poles comprises a top end and a bottom end;
a plurality of slidable connectors; and
a plurality of support members, wherein each of the plurality of support members comprises a first end and a second end, the first end of each of the plurality of support members is configured to be connected to the bottom end of a first pole of the plurality of poles, and the second end of each of the plurality of support members is configured to be connected to one of the slidable connectors of the plurality of slidable connectors, the slidable connector configured to slidably connect to a second pole of the plurality of poles, wherein the first pole and second pole are different;
wherein the plurality of slidable connectors are configured so that sliding the second end of each of the plurality of support members from a first position to a second position closer to the bottom end of each pole of the plurality of poles transitions the collapsible support structure from a folded state to an unfolded state.

2. The collapsible support structure of claim 1, wherein the plurality of slidable connectors are configured to support the bottom portion in an elevated position off the ground when the collapsible support structure is in the unfolded state.

3. The collapsible support structure of claim 1, further comprising a top portion configured to be removably attached to the top end of each of the plurality of poles.

4. The collapsible support structure of claim 1, further comprising side portions configured to enclose an interior volume when the collapsible support structure is in the unfolded state.

5. The collapsible support structure of claim 4, wherein the side portions comprise an opening portion that can be configured to provide access to the interior volume and to be closed such that less access is provided to the interior volume.

6. The collapsible support structure of claim 1, wherein the plurality of support members form a crisscross pattern around a perimeter of the collapsible support structure when the collapsible support structure is in the unfolded state.

7. The collapsible support structure of claim 1, further comprising one or more wheels.

8. The collapsible support structure of claim 1, wherein the collapsible support structure is configured for use as at least one of: an enclosure for a pet, a storage container, a playpen, or a cot.

9. The collapsible support structure of claim 1 in combination with a carry case configured to transport the structure when the collapsible support structure is in the folded state.

10. The collapsible support structure and carry case of claim 9, wherein the carry case comprises a back pack.

11. A method of using a collapsible support structure, said collapsible support structure comprising a bottom portion; a plurality of poles, each of the plurality of poles comprising a top end and a bottom end; a plurality of slidable connectors; and a plurality of support members, each of the plurality of support members comprising a first end and a second end, the second end configured to be connected to a slidable connector of the plurality of slidable connectors, said method comprising:
sliding each of said slidable connectors from a first position along each of the plurality of poles to a second position along each of the plurality of poles to transition the collapsible support structure from a folded state to an unfolded state; and
providing a gap between the bottom portion and the ground when the support structure is in the unfolded state, the bottom portion capable of supporting at least one of a human, a pet, or a physical object on the bottom portion when the collapsible support structure is in the unfolded state.

12. The method of claim 11, wherein the slidable connectors support the bottom portion in an elevated position off the ground when the collapsible support structure is in the unfolded state.

13. The method of claim 11, further comprising attaching a top portion adjacent the top end of each of the plurality of poles.

14. The method of claim 11, further comprising enclosing an interior volume of the collapsible support structure using side portions.

15. The method of claim 14, further comprising an opening in the side portion to provide access to the interior volume of the collapsible support structure.

16. The method of claim 11, further comprising extending the plurality of support members to form a crisscross pattern around a perimeter of the collapsible support structure when the collapsible support structure is in the unfolded state.

17. The method of claim 11, further comprising sliding the collapsible support structure using one or more wheels.

18. The method of claim 11, further comprising using the collapsible support structure for at least one of: an enclosure for a pet, a storage container, a playpen, or a cot.

19. The method of claim 11, further comprising carrying the collapsible support structure with a carry case.

20. The method of claim 19, further comprising carrying the carry case as a back pack.
